(19) United States
(12) Patent Application Publication
(10) Pub. No.: US 2016/0050887 A1
(43) Pub. Date: Feb. 25, 2016

(54) MULTI-LOOPED DOG LEASH

(71) Applicants: Leah Polcyn, Los Angeles, CA (US); Mark Polcyn, Los Angeles, CA (US)

(72) Inventors: Leah Polcyn, Los Angeles, CA (US); Mark Polcyn, Los Angeles, CA (US)

(21) Appl. No.: 14/830,565

(22) Filed: Aug. 19, 2015

Related U.S. Application Data
(60) Provisional application No. 62/039,352, filed on Aug. 19, 2014.

(51) Int. Cl. A01K 27/00; D05B 93/00

(52) U.S. Cl. CPC A01K 27/003; D05B 93/00

(57) ABSTRACT

Described is a multi-looped dog leash formed of an elongated material having a handle end and a dog end, with a length extending, therebetween. A plurality of handle loops are formed along the length of the elongated material between the handler end and dog end. The elongated material is a continuous piece of fabric folded onto itself and stitched at stitching points to form the plurality of handle loops.

CROSS-REFERENCE TO RELATED APPLICATIONS

This is a non-provisional patent application of U.S. Provisional Application No. 62/039,352, filed on Aug. 19 2014, the entirety of which is hereby incorporated by reference.

### BACKGROUND OF INVENTION

(1) Field of Invention

The present invention is related to a dog leash and more particularly, to a do leash having multiple handle loops arranged along a length of the dog leash.

(2) Description of Related Art

Dog leashes are typically fabric straps or cords that have a dog end and a handler end. The handler end includes a handle, while the dog end includes a clip attachment for attaching to a dog's collar. Such leashes are commonly made of a single predetermined length, allowing the handler to walk the dog with the leash stretched to the predetermined length. In some circumstances, it is desirable for the handler to shorten the length of the leash to further control the animal. To address this need, retractable leashes have been devised that allow a handler to selectively extend or retract the leash length. While functional for small or easily controlled dogs, retractable leashes suffer from the thin cord and retractable mechanism. In other words, retractable leashes are not sufficiently durable or strong for walking or training large and feisty dogs.

Thus, a continuing need exists for a strong dog leash that allows a handler to selectively alter the length from which the dog is extended from the handler.

### SUMMARY OF INVENTION

Described is a multi-looped dog leash formed of an elongated material having a handle end and a dog end, with a length extending therebetween. A plurality of handle loops are formed along the length of the elongated material between the handler end and dog end. The elongated material is a continuous piece of fabric folded onto itself and affixed at affixing points to form the plurality of handle loops.

In another aspect, each handle loop has a straight side and a loop side, such that fabric forming the straight side is shorter than fabric forming the loop side.

Finally, as can be appreciated by one in the art, the present invention also comprises a method for forming and using the invention described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is an illustration of a multi-looped leash according to the principles of the present invention;

FIG. 2 is an illustration of a method for making a multi-looped leash according to the principles of the present invention;

FIG. 3 is an illustration of a multi-looped leash according to the principles of the present invention and

FIG. 4 is an illustration of a multi-looped leash according to the principles of the present invention.

### DETAILED DESCRIPTION

The present invention is related to a dog leash and, more particularly, to a dog leash having multiple handle loops arranged along a length of the dog leash. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” the claims herein is not intended to invoke the provisions of 35 U.S.C. 112. Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

(1) Description

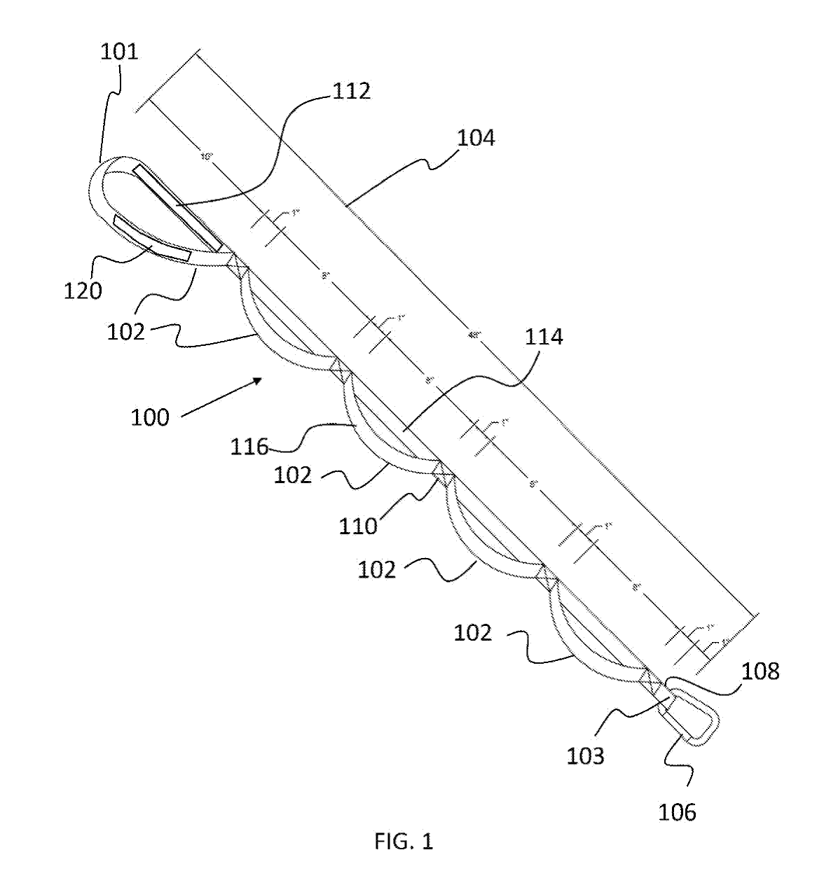

As noted above and as shown in FIG. 1, the present invention is directed to a dog leash 100 with multiple handle loops 102. The dog leash 100 is formed of an elongated material to have a handler end 101 and a dog end 103, with a length 104 extending therebetween. Multiple handle loops 102 (3or more) are arranged along the length 104 of the dog leash 100 from the handler end 101 to the dog end 103.

In some embodiments, the dog end 103 includes an attachment loop 108 that allows for attachment of an attachment device 106. Thus, to easily attach the leash 100 to a dog collar, the attachment device 106 is attached with the attachment loop 108. The attachment device 106 is any suitable mechanism or device to allow a handler to selectively attach/detach the leash 100 from a dog's collar, a non-limiting example of which includes a carbineer.

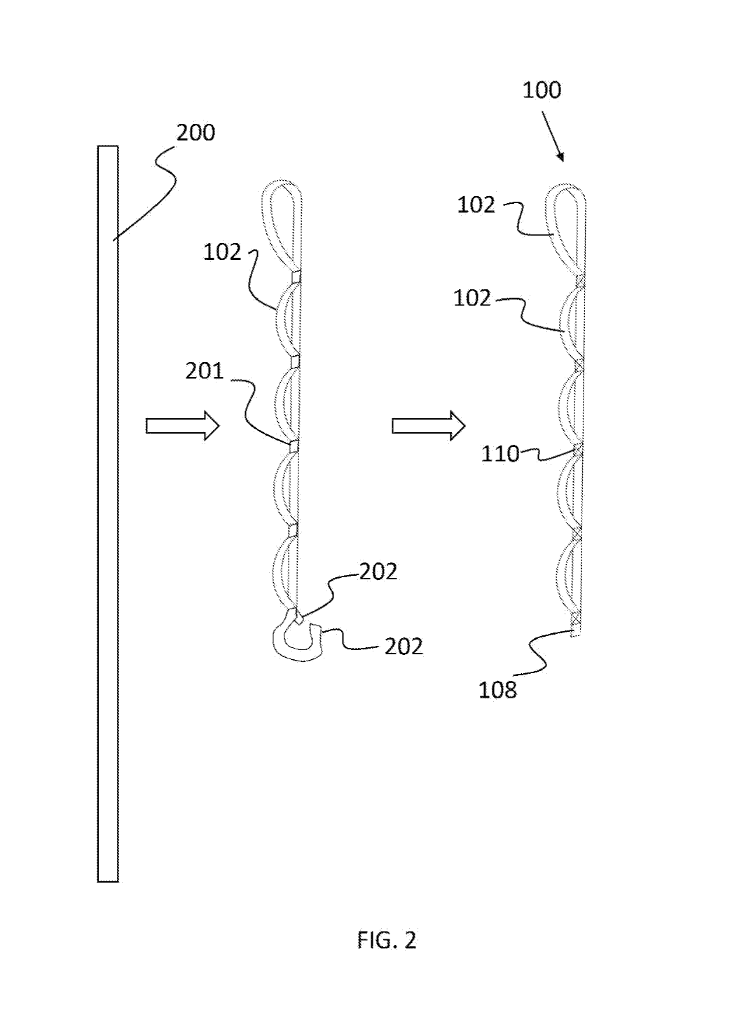

The elongated material forming the leash 100 is any suitably durable and strong fabric, a non-limiting example of which includes nylon, rope, or any other similarly soft yet durable material. In one aspect and as shown in FIG. 2, the leash 100 can be formed by folding a fabric strip 200 (e.g., nylon strip or rope) in half (or at any other desired location) over itself, with the handle loops 102 formed by affixing (e.g., stitching) the two fabric halves together at various affixing (e.g., stitching) points 201, forming blocks of stitching 110 (in some embodiments). The attachment loop 108 can be formed, for example, by folding ends 202 of the strip 200 against one another and affixing (e.g., stitching) the ends together 202.

It should be noted that the stitching technique listed above is provided as a non-limiting example of a technique for affixing the components together as the invention is not intended to be limited thereto. For example, any other suitable technique can be employed in place of stitching, such as using a rubber strap, such as a band, around the two pieces of fabric to hold the fabric together. Thus, in essence, the two fabric components are affixed together at points (e.g., affixing points such as stitching points)) to form handle loops between the points.

As a non-limiting example, a nylon fabric strip that is approximately 12 feet, 3 inches long, and 1 inch wide, can be folded in approximately half and onto itself Two inches blocks of stitching 110 can be applied between each handle loop 102 to form the handle loops 102 (that are 6.5 inches long) and the attachment loop 108. As another non-limiting example and as illustrated in FIG. 1, an 8 foot long fabric strip can be folded in approximately half, with blocks of stitching that are 1 inch in size. Thus, it should be understood that the particular dimensions listed are for example purposes only and that the invention is not intended to be limited thereto as it can be formed to accommodate different sized dogs and handlers as desired.

In some embodiments and as illustrated in FIG. 1, the leash 100 can be formed such that one side of the leash is straight (i.e., straight side 114), while the other side (i.e., loop side 116) of the leash has additional fabric or material (e.g., 1 inch of fabric) that is included at each handle loop 102. An advantage to such a configuration is that the extra material forming the handle loop 102 causes the handle loop 102 to protrude slightly to assist a handler in easily grabbing a handle loop 102 (at the desired location), while the straight side is taut so that the handler can easily pull or control the dog.

In some embodiments a thin lining 112 of material can be optionally included or otherwise stitched inside one or more of the handle loops 102 for extra comfort. As a non-limiting example, foam, neoprene, or any other material can be included as the thin lining.

In some embodiments, the leash 100 can be formed to include a reflective material 120 that is attached (e.g., stitched, adhered, etc.) to the outside surface of the leash 100 to increase visibility during night walks.

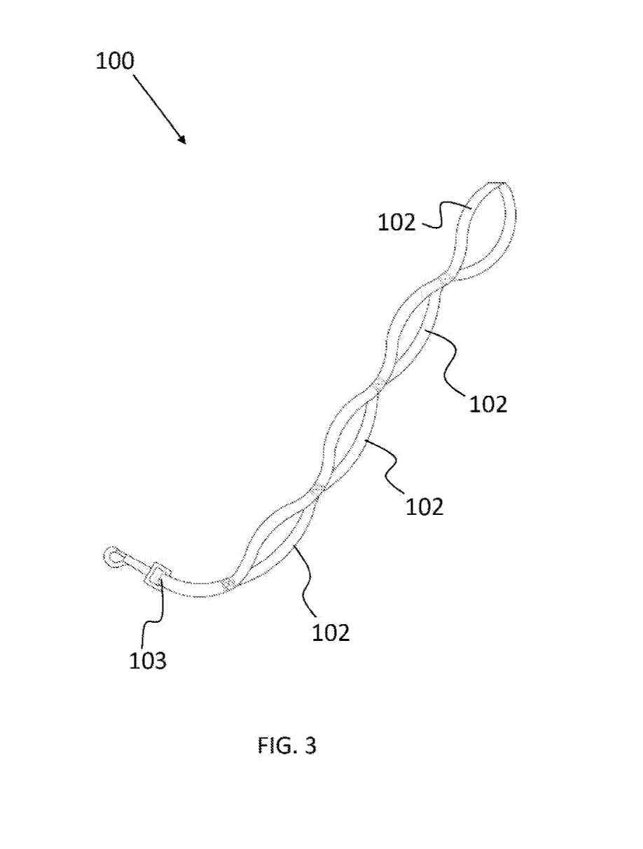

Another example of the leash 100 is illustrated in FIG, 3. As depicted, the leash 100 includes a plurality of handle loops 102 spread along the length of the leash 100. As was the case above, the plurality of handle loops 102 allow a handler to selectively use a handle loop 102 at the desired distance from the dog end 103 to control the slack provide to the dog on the leash 100. To be contrasted with the embodiment depicted in FIG. 1, the embodiment depicted in FIG. 3 includes handle loops 102 without a straight side. In other words, the fabric on each side of each handle loop 102 is approximately the same length (whereas in FIG. 1, the fabric on the straight side 114 is shorter than the fabric on the loop side 116). It should also be appreciated that the leash 100 can be formed with any combination of handle loop 102 configurations, such that some have a straight side 114 and others do not.

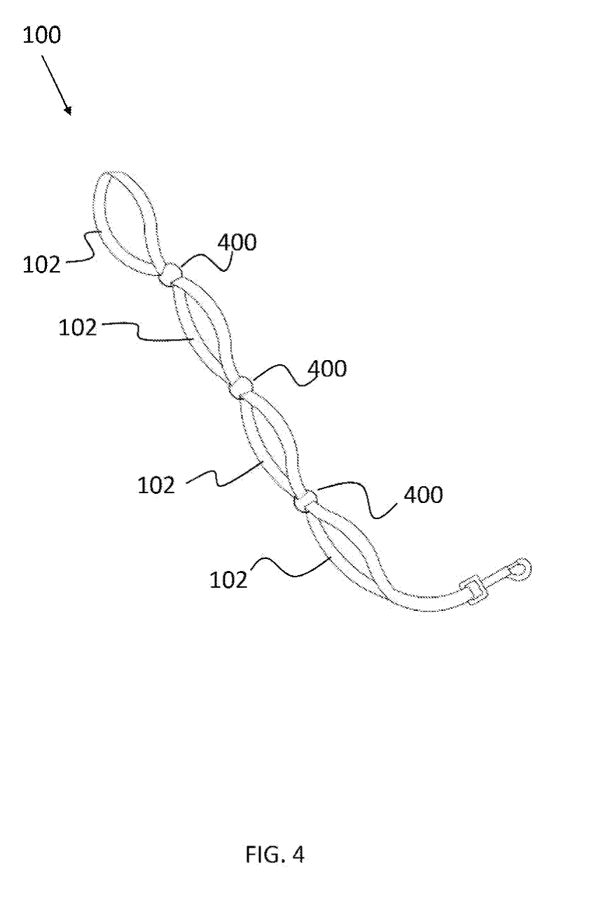

In some embodiments and as depicted in FIG. 4, the leash 100 can be formed by connecting a plurality of handle loops 102 with loop connectors 400. The loop connectors 400 are any suitable mechanism or device that is operable for connecting loops together, non-limiting examples of which include metal rings and a carabineer. In sonic embodiments, the handle loops 102 are fabric loops that are strips of fabrics stitched onto themselves to form the handle loops 102, with the loop connectors 400 being used to connect the various handle loops 102.

While desired embodiments of the invention has been illustrated and described, it is understood that various modifications might be made.

Accordingly, it is understood that the invention is not limited to the disclosed embodiments, but rather it is intended to include all embodiments which would be apparent to one skilled in the art and which come within the spirit and scope of the invention.

What is claimed is:

1. A multi-looped dog leash, comprising:
an elongated material having a handle end and a dog end, with a length extending therebetween; and
a plurality of handle loops formed along the length of the elongated material between the handler end and the dog end.

2. The multi-looped dog leash according to claim 1, wherein the elongated material is a continuous piece of fabric folded onto itself and affixed at affixing points to form the plurality of handle loops.

3. The multi-looped dog leash according to claim 1, wherein each handle loop has a straight side and a loop side, such that fabric forming the straight side is shorter than fabric forming the loop side.

4. A method for making a multi-looped dog leash, comprising acts of
folding a fabric strip over itself to form two fabric halves; and
forming a plurality of handle loops by affixing the two fabric halves together at a plurality of affixing points to form handle loops therebetween.
